(19) United States
(12) Patent Application Publication
(10) Pub. No.: US 2025/0276474 A1
(43) Pub. Date: Sep. 4, 2025

(54) A METHOD OF FORMING A PROTECTIVE ARTICLE AND 3D PRINTER

(71) Applicant: TECH 21 LICENSING LIMITED, Richmond, Surrey (GB)

(72) Inventors: Haim Geva, Richmond (GB); James Gardner, Richmond (GB); Hakimah Aziz, Richmond (GB)

(21) Appl. No.: 18/859,476

(22) PCT Filed: Apr. 24, 2023
(86) PCT No.: PCT/GB2023/051079

§ 371 Date: Oct. 23, 2024

(30) Foreign Application Priority Data
Apr. 26, 2022 (GB) 2206059.4

(51) Int. Cl. B29C 44/50; B29C 44/02; B29C 44/04; B29C 44/34; B29C 64/336; B33Y 10/00; B33Y 30/00; B33Y 40/10; B33Y 70/00

(52) U.S. Cl. CPC B29C 44/50; B29C 44/022; B29C 44/04; B29C 44/3446; B29C 64/336; B33Y 10/00; B33Y 30/00; B33Y 40/10; B33Y 70/00

(57) ABSTRACT

A method of forming a protective article, comprises feeding pellets (2) of a first and second different and immiscible polymers with a foaming agent to an extruder (4) with a screw (6). The polymers are melted and mixed in the extruder screw (6). The mixture is extruded through a 3D printing nozzle (7) and ejected to create a pressure drop to cause foaming of at least one of the polymers. An article is then printed from the foamed mixture. A 3D printer with two hoppers (1,11) for pellets to feed an extruder (4) with a screw (6).

The present invention relates to a method of forming a protective article.

In particular, it relates to a method of forming an impact absorption pad. Such pads are useful in any application where impact protection is required. This may, for example, be for protecting electronic items such as phones, tablets and laptops or may be for protective clothing, for example, industrial clothing or sportswear, for example, protective gloves, helmets, jackets, trousers etc. in applications such as cycling and motorcycling. The invention also extends to a 3D printer for making these pads and other articles.

Impact protection pads have conflicting requirements. They are required to give high levels of impact protection, while still being light and flexible enough to allow them to be comfortably worn. Known techniques for forming impact absorbing pads, include for example, using foaming techniques or injection moulding techniques. Different layers may be produced by different techniques to provide a layered structure with enhanced impact absorbing features.

KR102355157 discloses a 3D printing technique for making various articles. This uses foamable and non foamable filaments which are discharged from the same nozzle in order to create a layered structure.

The present invention aims to improve on the prior art.

According to a first aspect of the present invention, there is provided a method of forming a protective article according to claim 1.

The present invention relies on the use of at least two immiscible or essentially immiscible polymers. However, from a processing perspective, the immiscible polymers are compatible in that they are able to form a consistent or essentially consistent polymer melt. In the present invention, the immiscible polymer pellets are melted and extruded through a 3D printing nozzle together with a foaming agent or plurality thereof. Upon exit from the 3D printing nozzle, the homogenized polymer melt experiences a pressure drop causing the polymer melt to expand and form a foam which is then used to print the protective article.

Thus the polymers used in the present invention are immiscible or essentially immiscible from a chemical perspective but compatible from a processing perspective.

The present invention requires that the foam that is formed comprises (at least) two phases—a collapsible one and a resilient one. The (at least) two phases enable the formed foam and protective article to achieve impact protection performance.

The first and second polymers typically have different (final) properties such as, for example, different properties selected from one or more of density (e.g. measured according to ISO 60), compression set (e.g. measured according to ISO 1856), resilience (e.g. measured according to ISO 8307), storage and/or loss moduli (e.g. measured according to ISO 6721). Preferably, the first polymer comprises or consists of a thermoplastic elastomer, and the second polymer preferably comprises or consists of a thermoplastic engineering polymer. Typically, the second polymer, e.g., thermoplastic engineering polymer, will be harder, stiffer, and have a higher dimensional stability compared to the first polymer, e.g., thermoplastic elastomer.

Hardness may be determined in a conventional manner in accordance with, e.g., ISO 1923. The measurement is typically carried out using a durometer and may be expressed as a number on a suitable Shore scale, e.g., Shore OO, Shore A or Shore D.

The present invention provides a number of benefits. The end product is the foamed article formed of (at least) two different polymers, i.e., the first polymer and the second polymer. The first polymer is preferably relatively soft and resilient and therefore the foam of the first polymer is well suited to absorb low energy impacts and to provide flexibility to the article. The second polymer is preferably such as to produce a harder foam, which provides enhanced high energy absorption as the high energy impact causes, in use, collapse of the cells in the hard foam. The fact that the article, e.g. a pad, is 3D printed allows a complex shape to be formed in a single processing step.

The present invention provides significant advantages over KR102355157 which uses filaments of resin which are driven through the nozzle. These filaments have to be created in a separate manufacturing step. By contrast, the present invention creates the finished article directly from pellets thereby providing a significant cost saving. Techniques using filaments can only be used with relatively hard materials, thereby limiting their use. The filament technique is not intended to provide significant mixing of the resins as the filaments are extruded side by side from the nozzle. By contrast, in the present invention pellets are mixed in an extruder screw such that the end products are fundamentally different from those produced in KR102355157.

The relative quantities of the two polymers may remain fixed throughout the process and can be tuned to meet the requirements of the article. However, by varying the amount of one or both polymers and/or the amount of foaming agent fed to the extruder, the method can be used to produce a protective article with properties which vary in different parts of the article. This is particularly useful for a protective article where high degrees of protection can be focused into areas more likely to receive the high impact. A higher amount of the second polymer can be concentrated in these regions. These can be interposed with other regions with a higher concentration of the first polymer which provides greater flexibility to the article.

The foaming agent may be selected to cause foaming of only one of the polymers to form a final material with a foamed and an unfoamed polymer. That is, foaming may occur in the first polymer or the second polymer. However, more preferably, the foaming agent causes foaming of both of the first and second polymers.

The method may further involve the use of one or more additional polymers with different properties from the first and second polymers. This may be used simultaneously with the first and second polymers, or one of the first and second polymers may be phased out before the additional polymer(s) is/are introduced. Four or more polymers can be used with the same technique. The foaming agent can be changed during the polymer changes if necessary. The foaming agent may be selected to cause foaming of the one or more additional polymers in the same way that it causes foaming of the first and/or second polymers.

The polymers and foaming agent may be fed from a single hopper to the extruder. This represents the simplest form of the method. In this case, changes to the properties of the article can be made by changing the materials and or relative amounts of material in the hopper.

However, for greater flexibility more than one hopper may be used and the hoppers feed different materials to the extruder. This allows the composition of the finished article to be more easily varied during the printing process as the feeds from the different hoppers can be varied to provide the required blend. There may be one hopper for each different polymer and one for each different foaming agent for maximum flexibility. Alternatively, one or more polymer and/or foaming agent may be combined in a single hopper if desired.

According to a second aspect of the invention there is a 3D printer according to claim 9.

This provides a printer for producing 3D printed articles from a mixture of materials. As the printer uses hoppers that receive pellets, it provides a simple and versatile way of producing a variety of 3D printed materials. As it does not rely on filaments being fed to the nozzle, it can be used with a variety of materials, particularly softer materials unsuited to a filament process. The use of separate hoppers each with their own conveyor allows the properties of the material to be varied during the printing process and the presence of the extruder screw ensures that these materials are well mixed at the nozzle. In addition, if different materials are fed from the same hopper, there can be a problem of stratification of the materials in the hopper if the materials have different densities and/or particle sizes. This avoided if they are fed from different hoppers as the pellets of different materials do not meet until they reach the extruder.

The printer may be used for forming the foamed protective article of the first aspect of the invention, or for forming any other article (foamed or non-foamed) where a well-mixed mixture of materials is required.

The first and second conveyors may be in the form of gravity feeds or conveyor belts but are more preferably screw feeds.

Examples of methods and a 3D printer in accordance with the present invention will now be described with reference to the accompanying drawings, in which:

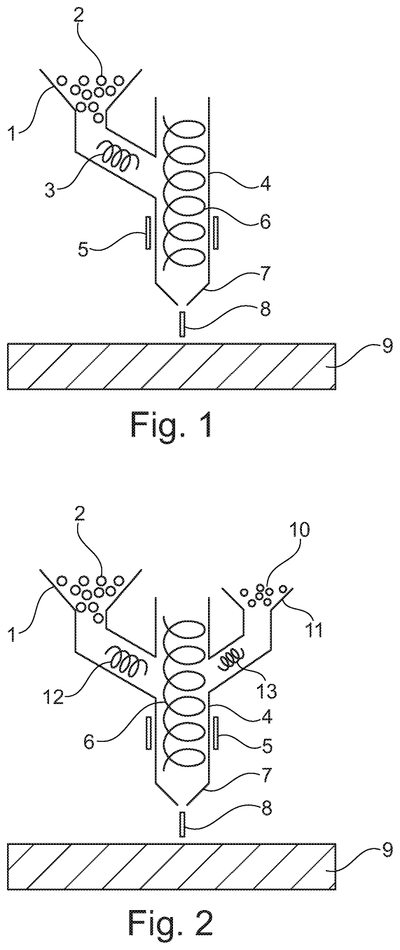

FIG. 1 is a schematic drawing of a first method; and

FIG. 2 is a similar schematic drawing of a second method and a 3D printer according to a second aspect of the invention.

As shown in FIG. 1, the hopper 1 is filled with a pre-mix 2 containing pellets of first and second polymers, together with a foaming agent.

This is initially formed as a pre-mix dry-blend. There may be two or more polymers within the blend. At least one of the polymers, which is subsequently referred to as the first polymer, is suitable to be formed into a soft, resilient foam. The second polymer is suitable to formed into a hard, collapsible foam. The polymers should be compatible for processing purposes, meaning that they are required to form a blend that can be consistently extruded.

A preferred blend uses a first polymer which is or comprises a Styrene Ethylene Butylene Styrene (SEBS)) thermoplastic elastomer (TPE) or a SEBS-based TPE. The second polymer is or comprises a high-impact polystyrene (HIPS). Alternative blends may include combinations of, e.g., EVA-based elastomers with HIPS, or with a polyolefin, TPU with polycarbonate or PET.

Various blends of up to 100% of each of the first or second polymers may be used and these provide a foam for the finished article which is useful in different impact scenarios.

The foaming agent is typically added to the dry blend in the hopper. The foaming agent (also known as a blowing agent) may be chemical, physical, or a combination of both. The concentration of the foaming agent can be adjusted and optimized to achieve a target foam density or article weight. In one embodiment, the chemical foaming agent may be added as a concentration of 1 to 2 wt. %, e.g., 1.5 wt %. Alternatively, or in combination, the physical blowing agent may be varied between, e.g., 5-15 wt %, depending on the required part weight part.

Examples of conventional chemical foaming agents include one or more of sodium bicarbonate, citric acid, azodicarbonamide, 4,4′-oxybis (benzenesulfonylhydrazide), 5-phenyl tetrazole, and p-toluenesulfonyl semicarbazide. Typically, these substances decompose to produce nitrogen, carbon dioxide or water during the foaming process.

Examples of conventional physical foaming agents include one or more of water, carbon dioxide, nitrogen or hydrocarbons such as pentane. These substances can be added directly into the polymer melt. Another example of a physical blowing agent is gas-containing expandable microspheres which can, for example, be added to the polymer as a dry-blend.

The dry blend is then fed by a conveyor screw 3 into an extruder 4 mounted to the frame of a 3D printer. The dry blend is heated by a heater 5 in the extruder and advanced along the extruder by a helical screw 6 towards 3D printing nozzle 7. The melted polymer and foaming agent leave the nozzle as a combined jet 8. The polymer is caused to foam by the sudden pressure drop, which occurs as it leaves the nozzle. The extruded material lands on a print bed 9 where foaming may optionally continue in a controlled manner for a short time.

The method according to the present invention allows for considerable variation of the end products depending upon the choice of polymers and foaming agent. For example, the foaming agent may be selected such that it only foams the first polymer resulting in a soft-foam polymer with a hard un-foamed polymer. Conversely, if the foaming agent only foams the second polymer, this will form a hard-foam polymer with a soft un-foamed polymer. If the foaming agent is selected to foam both of the polymers, this will produce an article with a mixture of hard and soft foamed polymers.

The variation of the ratio of the two polymers can create materials with variable properties which are suitable for different impact protection scenarios. An apparatus particularly suitable for doing this is shown in FIG. 2. In this case, a first hopper 1 is provided with a pre-mix dry-blend of the polymers. The foaming agent 10 is provided in a separate hopper 11. Separate conveyor screws 12, 13 control the feed from the hoppers 1, 11 into the extruder 3, which then operates as described above. Varying the pre-mixed polymer and foaming agent, allows different material properties to be achieved at different regions within the same article.

Instead of the foaming agent being in the second hopper 11, this may be provided with one of the polymers while the other polymer is provided in the first hopper. The foaming agent may also be provided separately via a third hopper.

Varying the feed rates of the polymers and foaming agents during the printing process, can create materials which are suitable for different impact scenarios. A greater proportion of the harder second polymer will create a product which is less flexible as a whole but more suitable for high-energy impact absorption. Conversely, a higher proportion of the foam formed of the softer first polymer will lead to a product which is more flexible as a whole, but is limited to low-energy impact. Typically, material combinations dominated by softer foams will be suitable for multiple impact protection uses as the soft product provides resilience. Materials dominated by harder foams may be suitable for single-use impact protection uses.

Using this method, a product can be created in which harder foams dominate in regions which are more likely to receive high impacts, while the softer foam can be used in other regions such that the overall product is more conformable.

Additional components can be incorporated into the product, either in the same hoppers and feeders or by, e.g., adding additional hoppers and feeders.

Conventional additives may be added to the first and/or second polymers and also to any additional polymers that are present.

If different products are formed in this 3D printer the foaming agent may be omitted.

1. A method of forming a protective article, the method comprising the steps of:
feeding pellets of a first polymer to an extruder;
feeding pellets of a second polymer, different from and immiscible with the first polymer, to the extruder;
feeding a foaming agent to the extruder;
melting the polymers;
mixing the polymers in an extruder screw;
extruding a mixture of the polymers and foaming agent through a 3D printing nozzle;
ejecting the mixture from the 3D printing nozzle to create a pressure drop to cause foaming of at least one of the polymers; and
forming an article printed from the foamed mixture.

2. A method according to claim 1, wherein the second polymer is harder than the first polymer.

3. A method according to claim 1, further comprising varying the amount of one or both polymers and/or the amount of foaming agent fed to the extruder.

4. A method according to claim 1 wherein the foaming agent causes foaming of both of the polymers.

5. A method according to claim 1, further comprising feeding one or more additional polymers to the extruder

6. A method according to claim 5, wherein each or all of the one or more additional polymers is/are different from and/or immiscible with the first and/or second polymers.

7. A method according to claim 1, wherein the polymers and foaming agent are fed from a single hopper to the extruder.

8. A method according to claim 1, wherein more than one hopper is used and the hoppers feed different materials to the extruder.

9. A 3D printer comprising:
a first hopper for pellets of a first material;
a second hopper for pellets of a second material;
an extruder containing an extruder screw;
a first conveyor for conveying pellets of the first material from the first hopper to the extruder;
a second conveyor for conveying pellets of the second material from the second hopper to the extruder;
a heater for melting the first and second materials in the extruder;
a 3D printing nozzle positioned downstream of the extruder screw such that, in use, the extruder screw ejects the melted and mixed materials from the 3D printing nozzle.

10. A 3D printer according to claim 9, wherein at least one of the first and second conveyors is a screw feed.
